(19) United States
(12) Patent Application Publication
(10) Pub. No.: US 2018/0074200 A1
(43) Pub. Date: Mar. 15, 2018

(54) SYSTEMS AND METHODS FOR DETERMINING THE VELOCITY OF LIDAR POINTS

(71) Applicant: GM GLOBAL TECHNOLOGY OPERATIONS LLC, Detroit, MI (US)

(72) Inventors: MARK LIU, SAN FRANCISCO, MI (US); SEAN HARRIS, SAN FRANCISCO, CA (US); ELLIOT BRANSON, SAN FRANCISCO, CA (US)

(73) Assignee: GM GLOBAL TECHNOLOGY OPERATIONS LLC, Detroit, MI (US)

(21) Appl. No.: 15/820,139

(22) Filed: Nov. 21, 2017

(51) Int. Cl. G01S 17/58; G01S 17/89; G01S 7/48; G01S 17/02

(52) U.S. Cl. CPC G01S 17/58; G01S 17/023; G01S 7/4802; G01S 17/89

(57) ABSTRACT

A processor-implemented method in a vehicle for detecting the motion of lidar points includes: constructing a sequence of voxel grids surrounding the vehicle at each of a plurality of successive time increments wherein the sequence of voxel grids includes a voxel grid for the current time and a voxel grid for each of a plurality of past time instances, tracing in each voxel grid in the sequence, lidar beams from a lidar system on the vehicle through the voxel grid, analyzing differences across the sequence of voxel grids to produce a motion score for a plurality of regions in the voxel grid for the current time that characterizes the degree of motion in the region over the successive time increments, summing the motion scores of the regions across columns to produce a summed motion score for each column of regions, and producing a 2D image from the summed motion scores.

### TECHNICAL FIELD

The present disclosure generally relates to vehicle perception systems, and more particularly relates to systems and methods for determining the velocity of lidar points in vehicle perception systems.

### BACKGROUND

Vehicle perception systems have been introduced into vehicles to allow a vehicle to sense its environment and in some cases to allow the vehicle to navigate autonomously or semi-autonomously. Sensing devices that may be employed in vehicle perception systems include radar, lidar, image sensors, and others.

While recent years have seen significant advancements in vehicle perception systems, such systems might still be improved in a number of respects. For example, lidar may be used to detect objects near a vehicle. While lidar data can provide the distance of an object to the lidar system, many lidar systems cannot determine whether the detected object is in motion.

Accordingly, it is desirable to provide systems and methods for determining the relative motion of lidar points. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for detecting the motion of lidar points in vehicle perception systems. In one embodiment, a processor-implemented method in a vehicle for detecting the motion of lidar points and generating a two-dimensional (2D) top-down map that identifies moving objects includes: constructing, by the processor, a sequence of computer-generated voxel grids surrounding the vehicle at each of a plurality of successive time increments wherein the sequence of voxel grids includes a voxel grid for the current time and a voxel grid for each of a plurality of past time instances. The method further includes tracing, by the processor, in each voxel grid in the sequence, lidar beams from a lidar system on the vehicle through the voxel grid, analyzing, by the processor, differences across the sequence of voxel grids to produce a motion score for a plurality of regions in the voxel grid for the current time that characterizes the degree of motion in the region over the successive time increments, summing, by the processor, the motion scores of the regions across columns to produce a summed motion score for each column of regions, and producing, by the processor, a 2D image from the summed motion scores.

In one embodiment, the plurality of successive time increments includes at least eight successive time increments.

In one embodiment, constructing a sequence of computer-generated voxel grids includes constructing a voxel grid for the current time by adding voxels to a front face of a voxel grid for a prior time instance wherein the number of voxels added corresponds to the amount of vehicle movement in the front face direction and removing voxels from a rear face of the voxel grid for the prior time instance wherein the number of voxels removed corresponds to the amount of vehicle movement in the direction opposite to the rear face direction.

In one embodiment, analyzing differences across the sequence of voxel grids includes applying a machine learning classifier to the successive images.

In one embodiment, analyzing differences across the sequence of voxel grids includes applying a random forest classifier to the successive images.

In one embodiment, analyzing differences across the sequence of voxel grids to produce a motion score for a plurality of regions in the voxel grid includes: sub-dividing the voxel grid for the current time into a plurality of regions, identifying the regions in the voxel grid for the current time that contain occupied voxels, and producing a motion score for each identified region that characterizes the degree of motion in the identified region over the successive time increments by analyzing differences between the voxels in the identified regions and the voxels in corresponding regions in the voxel grids for past time instances.

In one embodiment, a region includes a rectangular prism of voxels.

In one embodiment, the 2D image identifies objects that are in motion.

In one embodiment, the 2D image identifies the velocity of objects that are in motion.

In one embodiment, an identified region includes a region wherein a lidar beam terminates in the center voxel of the region.

In one embodiment, tracing lidar beams through the voxel grid includes: assigning a first characteristic to a voxel if a lidar beam travels through the voxel, assigning a second characteristic to a voxel if no lidar beam travels through voxel, and assigning a third characteristic to a voxel if a lidar beam terminates at that voxel.

In one embodiment, the first characteristic is clear, the second characteristic is unknown, and the third characteristic is occupied.

In another embodiment, a processor-implemented method in a vehicle for determining the velocity of lidar points includes: constructing, by a processor, a voxel grid around the vehicle, identifying, by the processor, an object in the voxel grid, retrieving, by the processor, a sequence of camera images that encompass the object, matching, by the processor, pixels in the sequence of camera images that encompass the object to corresponding voxels in the voxel grid that encompass the object, determining, by the processor, the velocity of the pixels that encompass the object from the sequence of camera images, and inferring, by the processor, the velocity of the corresponding voxels that encompass the object based on the velocity of the pixels that encompass the object.

In one embodiment, determining the velocity of the pixels includes analyzing the movement of the object in successive images in the sequence of images.

In one embodiment, identifying an object in the voxel grid includes tracing lidar beams from a lidar system on the vehicle through the voxel grid.

In one embodiment, tracing lidar beams through the voxel grid includes: assigning a first characteristic to a voxel if a lidar beam travels through the voxel, assigning a second characteristic to a voxel if no lidar beam travels through voxel, and assigning a third characteristic to a voxel if a lidar beam terminates at that voxel.

In one embodiment, the first characteristic is clear, the second characteristic is unknown, and the third characteristic is occupied.

In one embodiment, identifying an object in the voxel grid includes identifying voxels that have been assigned an occupied characteristic.

In one embodiment, matching pixels in the sequence of camera images that encompass the object to corresponding voxels includes synchronizing the position and time of the pixels with the position and time of the voxels.

In another embodiment, an autonomous vehicle includes: an imaging system configured to generate image data, a lidar system configured to generate lidar data, and a velocity mapping system configured to infer from the image data the velocity of voxels that encompass an object based on the velocity of pixels in the image data. The velocity mapping system includes one or more processors configured by programming instructions encoded in non-transient computer readable media. The velocity mapping system is configured to: construct a voxel grid around the vehicle, identify an object in the voxel grid, retrieve a sequence of camera images that encompass the object, match pixels in the sequence of camera images that encompass the object to corresponding voxels in the voxel grid that encompass the object, determine the velocity of the pixels that encompass the object from the sequence of camera images, and infer the velocity of the corresponding voxels that encompass the object based on the velocity of the pixels that encompass the object.

### DESCRIPTION OF THE DRAWINGS

The exemplary embodiments will hereinafter be described in conjunction with the following drawing figures, wherein like numerals denote like elements, and wherein:

FIG. 1A depicts an example vehicle that includes a lidar (light detection and ranging) system, in accordance with various embodiments;

FIG. 1B presents a top down view of the example vehicle of FIG. 1A that illustrates the lidar system, in accordance with various embodiments;

FIG. 1C depicts an example voxel grid that may be visualized as being formed around the example vehicle of FIG. 1A in a computerized three-dimensional representation of the space surrounding the example vehicle, in accordance with various embodiments;

FIG. 2 is functional block diagram illustrating an autonomous driving system (ADS) associated with an autonomous vehicle, in accordance with various embodiments;

FIG. 3A is a block diagram of an example motion mapping system in an example vehicle, in accordance with various embodiments;

FIG. 3B depicts a side view of an example voxel grid after lidar beam tracing operations, in accordance with various embodiments;

FIG. 4 is a process flow chart depicting an example process in a vehicle for detecting the motion of lidar points and generating a two-dimensional top-down map that identifies moving objects, in accordance with various embodiments;

FIG. 5 is a block diagram of an example velocity mapping system in an example vehicle, in accordance with various embodiments; and

FIG. 6 is a process flow chart depicting an example process in a vehicle for determining and outputting the velocity of lidar points, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

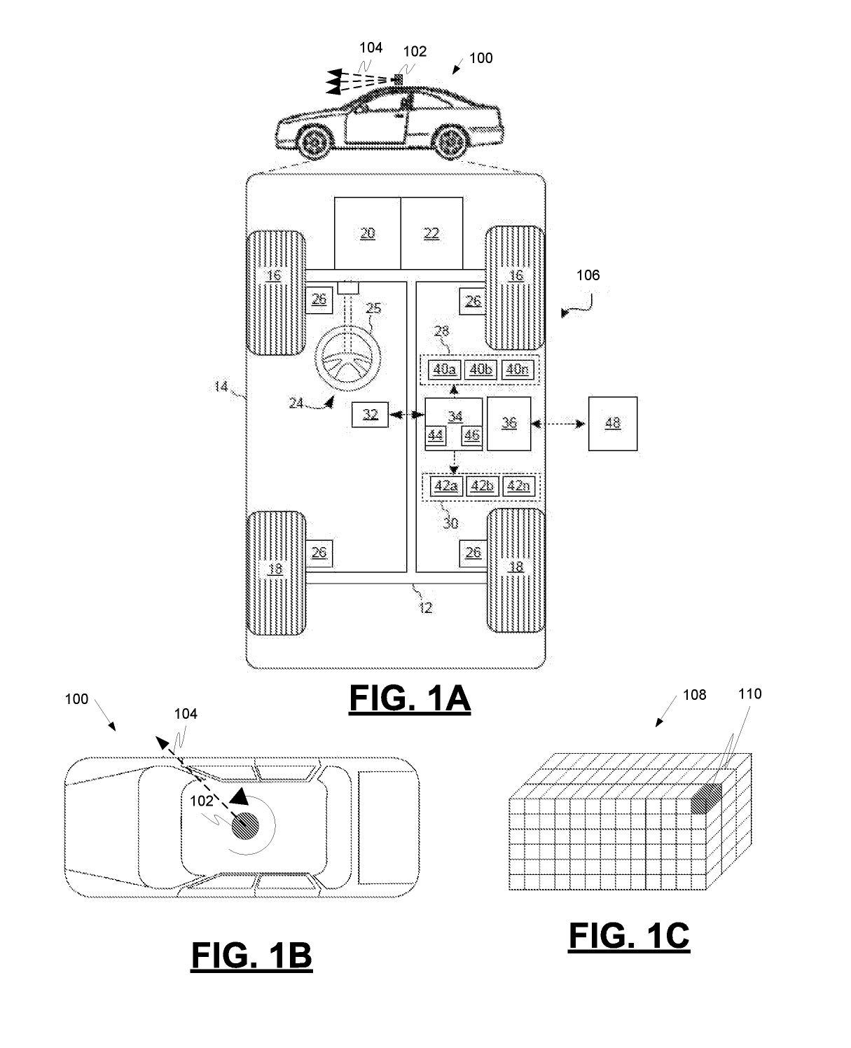

FIGS. 1A and 1B depict an example vehicle 100 that includes a lidar (light detection and ranging) system 102. FIG. 1A presents a side view of the example vehicle 100 and FIG. 1B presents a top down view of the example vehicle 100. The example lidar system 102 is mounted onto a surface (e.g., a top surface) of the example vehicle 100. The example lidar system 102 includes a sensor that rotates (e.g., in a counter-clockwise direction) and emits a plurality of light beams 104. The example lidar system 102 measures an amount of time for the light beams to return to the vehicle 100 to measure the distance to objects surrounding the vehicle 100. The example vehicle 100 includes a mapping system 106 that is configured to determine the relative motion of lidar points.

FIG. 1C depicts an example voxel grid 108 that may be visualized as being formed around the example vehicle 100 in a computerized three-dimensional representation of the space surrounding the example vehicle 100. The example voxel grid 108 is made up of a plurality of voxels 110 (with a single voxel shaded in this example). Each voxel 110 in the example voxel grid 108 may be characterized as being in one of three states: a clear state, an occupied state, or an unknown state. The voxel state is determined, in this example, based on whether a lidar beam 104 from the example vehicle 100 has entered or passed through the voxel 110. A voxel is considered to be in a clear state if from the lidar data it can be determined that a lidar beam would pass through the voxel before encountering an object. A voxel is considered to be in an occupied state if from the lidar data it can be determined that an object would be present at that voxel. A voxel is considered to be in an unknown state if the state of the voxel cannot be determined from the lidar data. Multiple contiguous voxels can be indicative of a single object or one or more clustered objects. The mapping system 106 is configured to indicate whether multiple contiguous voxels are indicative of a single object or one or more clustered objects.

As depicted in FIG. 1A, the vehicle 100 generally includes a chassis 12, a body 14, front wheels 16, and rear wheels 18. The body 14 is arranged on the chassis 12 and substantially encloses components of the vehicle 100. The body 14 and the chassis 12 may jointly form a frame. The wheels 16-18 are each rotationally coupled to the chassis 12 near a respective corner of the body 14.

In various embodiments, the vehicle 100 is an autonomous vehicle and the mapping system 104 is incorporated into the autonomous vehicle 100. The autonomous vehicle 100 is, for example, a vehicle that is automatically controlled to carry passengers from one location to another. The vehicle 100 is depicted in the illustrated embodiment as a passenger car, but other vehicle types, including motorcycles, trucks, sport utility vehicles (SUVs), recreational vehicles (RVs), marine vessels, aircraft, etc., may also be used.

In an exemplary embodiment, the autonomous vehicle 100 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any vehicle in which the present subject matter may be implemented, regardless of its level of autonomy.

As shown, the autonomous vehicle 100 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 100 (such as the state of one or more occupants) and generate sensor data relating thereto. Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 100 may also include interior and/or exterior vehicle features not illustrated in FIG. 1A, such as various doors, a trunk, and cabin features such as air, music, lighting, touch-screen display components (such as those used in connection with navigation systems), and the like.

The data storage device 32 stores data for use in automatically controlling the vehicle 100. In various embodiments, the data storage device 32 stores defined maps of the navigable environment. In various embodiments, the defined maps may be predefined by and obtained from a remote system. For example, the defined maps may be assembled by the remote system and communicated to the autonomous vehicle 100 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 100. In various embodiments, controller 34 is configured to implement a mapping system as discussed in detail below.

The instructions may include one or more separate programs, each of which comprises an ordered listing of executable instructions for implementing logical functions. The instructions, when executed by the processor 44, receive and process signals (e.g., sensor data) from the sensor system 28, perform logic, calculations, methods and/or algorithms for automatically controlling the components of the autonomous vehicle 10, and generate control signals that are transmitted to the actuator system 30 to automatically control the components of the autonomous vehicle 100 based on the logic, calculations, methods, and/or algorithms. Although only one controller 34 is shown in FIG. 1A, embodiments of the autonomous vehicle 100 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 100.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

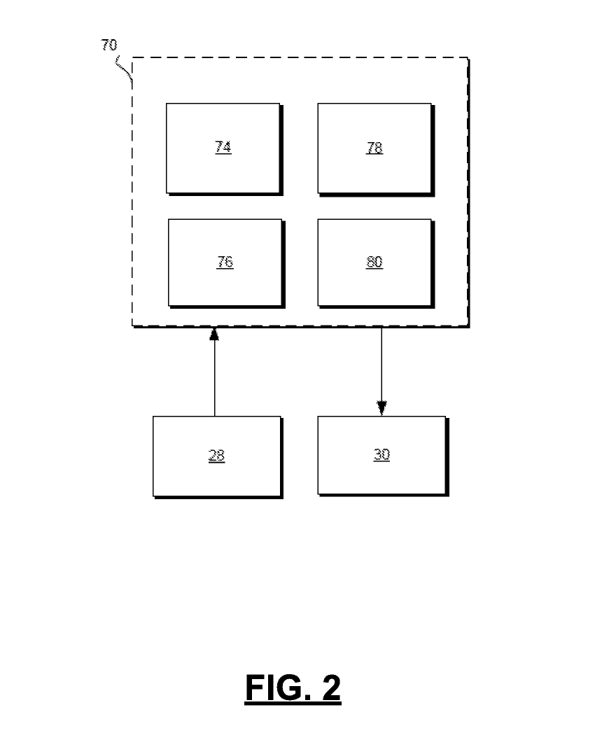

In accordance with various embodiments, controller 34 implements an autonomous driving system (ADS) 70 as shown in FIG. 2. That is, suitable software and/or hardware components of controller 34 (e.g., processor 44 and computer-readable storage device 46) are utilized to provide an autonomous driving system 70 that is used in conjunction with vehicle 100.

In various embodiments, the instructions of the autonomous driving system 70 may be organized by function or system. For example, as shown in FIG. 2, the autonomous driving system 70 can include a perception system 74, a positioning system 76, a path planning system 78, and a vehicle control system 80. As can be appreciated, in various embodiments, the instructions may be organized into any number of systems (e.g., combined, further partitioned, etc.) as the disclosure is not limited to the present examples.

In various embodiments, the perception system 74 synthesizes and processes the acquired sensor data and predicts the presence, location, classification, and/or path of objects and features of the environment of the vehicle 100. In various embodiments, the perception system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 100 relative to the environment. As can be appreciated, a variety of techniques may be employed to accomplish this localization, including, for example, simultaneous localization and mapping (SLAM), particle filters, Kalman filters, Bayesian filters, and the like.

The path planning system 78 processes sensor data along with other data to determine a path for the vehicle 100 to follow. The vehicle control system 80 generates control signals for controlling the vehicle 100 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, all or parts of the mapping system 104 may be included within the perception system 74, the positioning system 76, the path planning system 78, and/or the vehicle control system 80. As mentioned briefly above, the mapping system 106 of FIG. 1A is configured to is configured to determine the relative motion of lidar points.

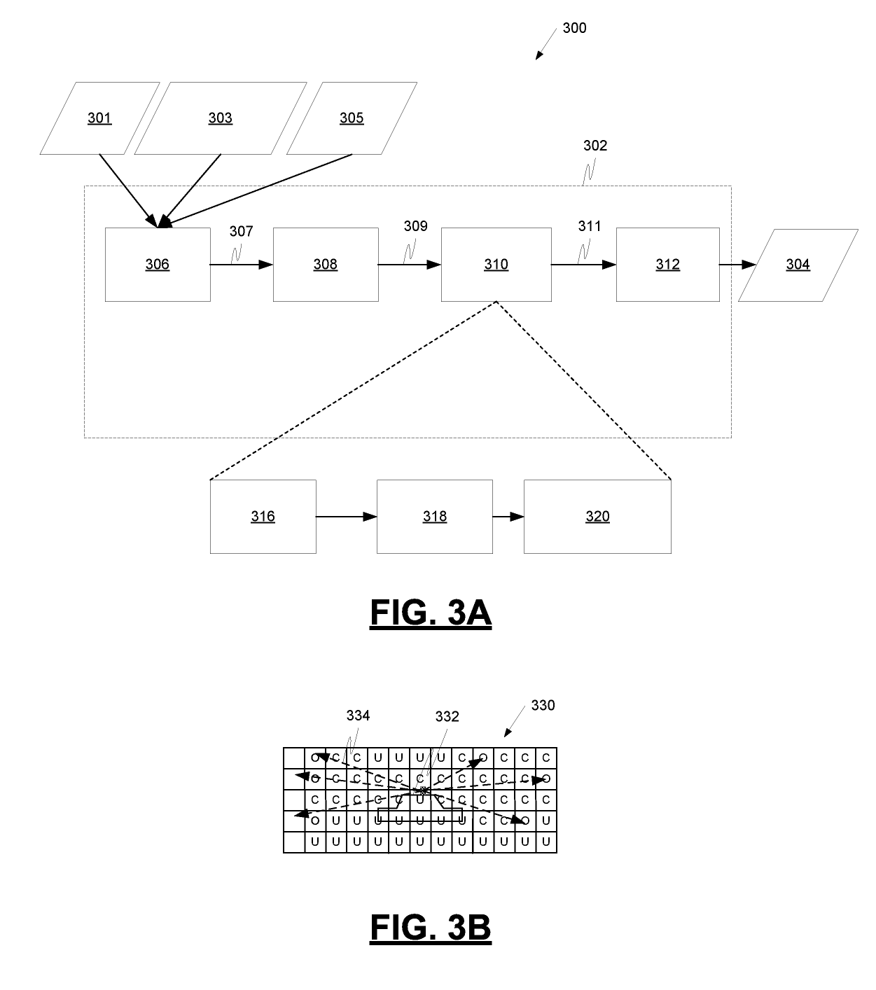

FIG. 3A is a block diagram of an example motion mapping system 302 in an example vehicle 300. The example motion mapping system 302 is configured to generate from lidar data a two-dimensional (2D) image 304 of an area surrounding the vehicle 300 that specifically identifies lidar points in the image 304 as stationary or in motion. To generate the image 304 that specifically identifies lidar points as moving or stationary, the example motion mapping system 302 is configured to construct a sequence of computer-generated voxel grids surrounding a vehicle at each of a plurality of successive time increments wherein the sequence of voxel grids includes a voxel grid for the current time and a voxel grid for each of a plurality of past time instances. The example motion mapping system 302 is further configured to trace, in each voxel grid in the sequence, lidar beams from a lidar system on the vehicle through the voxel grid, analyze differences across the sequence of voxel grids to produce a motion score for a plurality of regions in the voxel grid for the current time that characterizes the degree of motion in the region over the successive time increments, sum the motion scores of the regions across columns to produce a summed motion score for each column of regions, and produce a 2D image from the summed motion scores that identifies lidar points in motion and stationary lidar points. The example motion mapping system 302 includes a voxel grid generation module 306, lidar beam tracing module 308, motion scoring module 310, and column summing module 312.

The example motion mapping system 302 includes a controller that is configured to implement the voxel grid generation module 306, lidar beam tracing module 308, motion scoring module 310, and column summing module 312. The controller includes at least one processor and a computer-readable storage device or media encoded with programming instructions for configuring the controller. The processor may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the controller.

The example voxel grid generation module 306 is configured to construct a sequence of computer-generated voxel grids 307 surrounding a vehicle at each of a plurality of successive time increments wherein the sequence of voxel grids includes a voxel grid for the current time and a voxel grid for each of a plurality of past time instances. In this example, the plurality of successive time increments comprises at least eight successive time increments. The example voxel grid generation module 306 is configured to construct the voxel grids using retrieved lidar point cloud data 301, lidar position information 303 relative to the vehicle, and vehicle position information 305 from other vehicle systems. The example voxel grid generation module 306 is also configured to construct a voxel grid for the current time by shifting a voxel grid from a prior time instance based on vehicle movement since the prior time instance. The voxel grid may be shifted by both adding voxels to a front face of a voxel grid for a prior time instance wherein the number of voxels added corresponds to the amount of vehicle movement in the front face direction over the time increment and removing voxels from a rear face of the voxel grid for the prior time instance wherein the number of voxels removed corresponds to the amount of vehicle movement in the direction opposite to the rear face direction over the time increment.

The example lidar beam tracing module 308 is configured to trace, in each voxel grid in the sequence, lidar beams from a lidar system on the vehicle through a voxel grid 307. The example lidar beam tracing module is configured to trace lidar beams through a voxel grid 307 by characterizing a voxel as clear if a lidar beam travels through the voxel, characterizing a voxel as unknown if no lidar beam travels through voxel, and characterizing a voxel as occupied if a lidar beam terminates at that voxel. The example lidar beam tracing module 308 is configured to trace lidar beams using the lidar point cloud data 301, lidar position information 303 relative to the vehicle, and vehicle position information 305 from other vehicle systems. The example lidar beam tracing module 308 is configured to output traced voxel grids 309 after lidar beam tracing.

FIG. 3B depicts a side view of an example voxel grid 330 after lidar beam tracing operations. The example voxel grid 330 includes a plurality of voxels that are characterized by one of three states: a clear state (C), an occupied state (O), or an unknown state (U). A voxel is characterized as clear if a lidar beam travels through the voxel, characterized as unknown if no lidar beam travels through voxel, or characterized as occupied if a lidar beam terminates at that voxel. Also, overlaid onto the voxel grid 330 for illustrative purposes is an example vehicle 332 and example lidar beams 334.

Referring back to FIG. 3A, the example motion scoring module 310 is configured to analyze differences across the sequence of traced voxel grids 309 to produce a motion score 311 for a plurality of regions in the traced voxel grid 309 for the current time that characterizes the degree of motion in the region over the successive time increments. The example motion scoring module 310 includes a region identification (ID) module 316 that is configured to sub-divide the voxel grid for the current time into a plurality of regions. As an example, the voxel grid may be sub-divided into regions that consist of a rectangular prism of voxels such as a 3×3×3 rectangular prism of voxels or some other three-dimensional rectangular prism.

The example motion scoring module 310 further includes an occupied regions ID module 318 that is configured to identify the regions in the voxel grid for the current time that contain occupied voxels. In this example, a region is identified as containing occupied voxels when at least the center voxel is occupied (e.g., a lidar beam terminates in the center voxel of the region).

The example motion scoring module 310 further includes a region motion scoring module 320 that is configured to produce a motion score for each identified region. The motion score characterizes the degree of motion in the identified region over the successive time increments. The example region motion scoring module 320 performs the scoring by analyzing differences between the voxels in the identified regions and the voxels in corresponding regions in the voxel grids for past time instances. The differences are analyzed, in this example, using a machine learning classifier that is applied to the successive images. The example machine learning classifier may include an ensemble learning classifier such as a random forest classifier.

The example column summing module 312 is configured to sum the motion scores of the regions across columns to produce a summed motion score for each column of regions. As an example, for columns having regions that are stacked upon each other, the example column summing module 312 is configured to sum the scores for the stacked regions.

The example motion mapping system 302 is further configured to output the summed motion score for each column of regions as the image 304 that identifies lidar points in an area surrounding the vehicle 300 as stationary or in motion. The image 304 may be displayed as a top down view of the area surrounding a vehicle, display lidar points that are in motion, display stationary lidar points, and, in some examples, display the relative velocity of lidar points that are in motion.

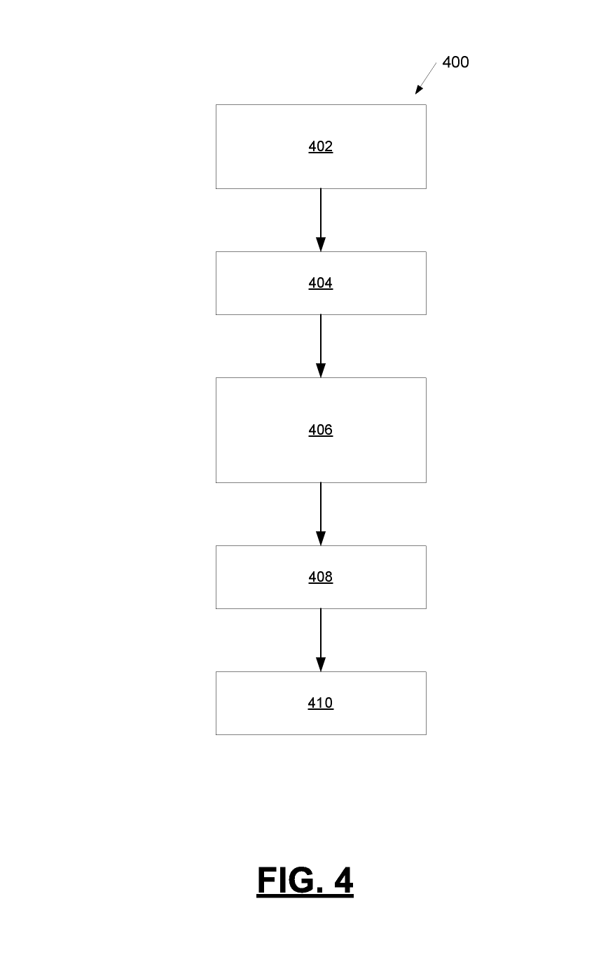

FIG. 4 is a process flow chart depicting an example process 400 in a vehicle for detecting the motion of lidar points and generating a two-dimensional top-down map that identifies moving objects. The order of operation within the process is not limited to the sequential execution as illustrated in the figure, but may be performed in one or more varying orders as applicable and in accordance with the present disclosure. In various embodiments, the process can be scheduled to run based on one or more predetermined events, and/or can run continuously during operation of the vehicle.

The example process 400 includes constructing a sequence of computer-generated voxel grids surrounding a vehicle at each of a plurality of successive time increments wherein the sequence of voxel grids includes a voxel grid for the current time and a voxel grid for each of a plurality of past time instances (operation 402). In this example, the plurality of successive time increments comprises at least eight successive time increments. The example voxel grids may be constructed using retrieved lidar point cloud data, lidar position information relative to the vehicle, and vehicle position information from other vehicle systems. The example voxel grid for the current time may be constructed by shifting a voxel grid from a prior time instance based on vehicle movement since the prior time instance. The voxel grid may be shifted by both adding voxels to a front face of a voxel grid for a prior time instance wherein the number of voxels added corresponds to the amount of vehicle movement in the front face direction over the time increment and removing voxels from a rear face of the voxel grid for the prior time instance wherein the number of voxels removed corresponds to the amount of vehicle movement in the direction opposite to the rear face direction over the time increment.

The example process 400 includes tracing, in each voxel grid in the sequence, lidar beams from a lidar system on the vehicle through the voxel grid (operation 404). Tracing lidar beams through the voxel grids may be accomplished by characterizing a voxel as clear if a lidar beam travels through the voxel, characterizing a voxel as unknown if no lidar beam travels through voxel, and characterizing a voxel as occupied if a lidar beam terminates at that voxel. Lidar point cloud data, lidar position information relative to the vehicle, and vehicle position information from other vehicle systems may be used during lidar beam tracing operations.

The example process 400 includes analyzing differences across the sequence of voxel grids to produce a motion score for a plurality of regions in the voxel grid for the current time that characterizes the degree of motion in the region over the successive time increments (operation 406). Analyzing differences across the sequence of voxel grids may include sub-dividing the voxel grid for the current time into a plurality of regions. As an example, the voxel grid may be sub-divided into regions that consist of a rectangular prism of voxels such as a 3×3×3 rectangular prism of voxels or some other three-dimensional rectangular prism. Analyzing differences across the sequence of voxel grids may further include identifying the regions in the voxel grid for the current time that contain occupied voxels. In this example, a region is identified as containing occupied voxels when at least the center voxel is occupied (e.g., a lidar beam terminates in the center voxel of the region). Analyzing differences across the sequence of voxel grids may further include producing a motion score for each identified region that characterizes the degree of motion in the identified region over the successive time increments. The motion score may be produced by analyzing differences between the voxels in the identified regions and the voxels in corresponding regions in the voxel grids for past time instances. The differences are analyzed, in this example, using a machine learning classifier that is applied to the successive images. The example machine learning classifier may include an ensemble learning classifier such as a random forest classifier.

The example process 400 includes summing the motion scores of the regions across columns to produce a summed motion score for each column of regions (operation 408). As an example, for columns having regions that are stacked upon each other, summing may include summing the scores for the stacked regions.

The example process 400 includes producing a 2D image from the summed motion scores (operation 410). The example 2D image provides a top down view that identifies lidar points in an area surrounding a vehicle as stationary or in motion and, in some examples, identifies the relative velocity of lidar points that are in motion.

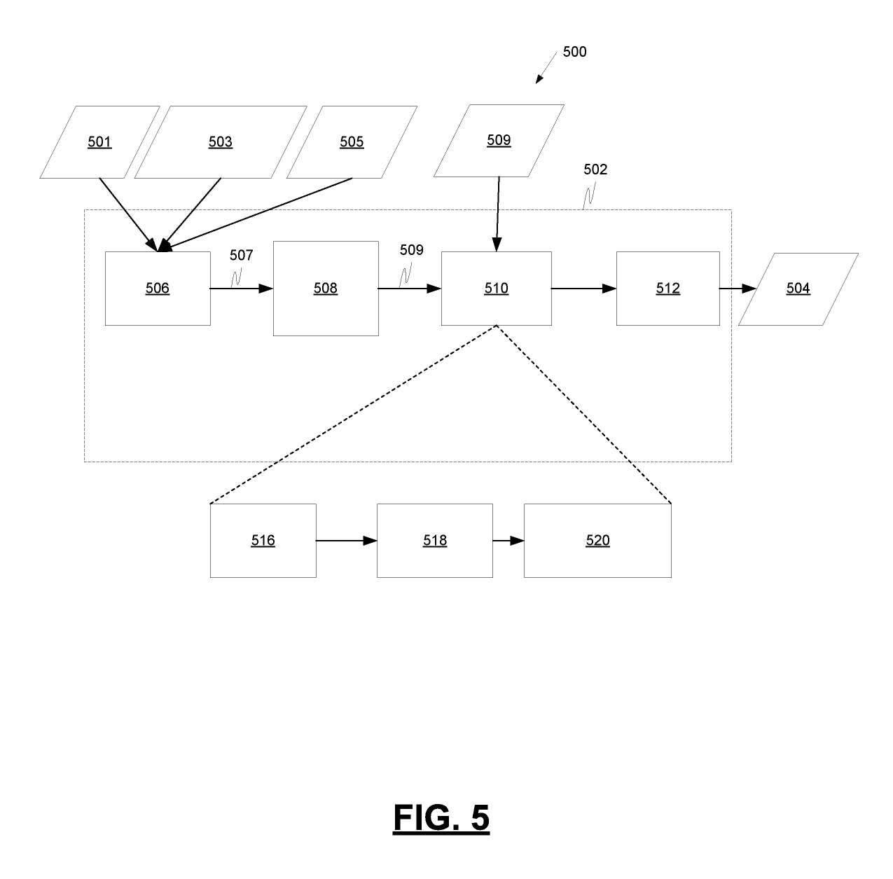

FIG. 5 is a block diagram of an example velocity mapping system 502 in an example vehicle 500. The example velocity mapping system 502 is configured to determine and output the velocity 504 of lidar points. To determine the velocity of lidar points, the example velocity mapping system 502 is configured to construct a voxel grid around a vehicle, identify an object in the voxel grid, retrieve a sequence of camera images that encompass the object, match pixels in the sequence of camera images that encompass the object to corresponding voxels in the voxel grid that encompass the object, determine the velocity of the pixels that encompass the object from the sequence of camera images, and infer the velocity of the corresponding voxels that encompass the object based on the velocity of the pixels that encompass the object.

The example velocity mapping system 502 includes a voxel grid generation module 506, an object identification/lidar beam tracing module 508, a pixel module 510, and a voxel velocity determination module 512. The example velocity mapping system 502 includes a controller that is configured to implement the voxel grid generation module 506, object identification/lidar beam tracing module 508, pixel module 510, and voxel velocity determination module 512.

The example voxel grid generation module 506 is configured to construct a voxel grid 507 around a vehicle. The example voxel grid generation module 506 is configured to construct the voxel grid 507 using retrieved lidar point cloud data 501, lidar position information 503 relative to the vehicle, and vehicle position information 505 from other vehicle systems. The example voxel grid generation module 506 is also configured to construct a voxel grid by shifting a voxel grid from a prior time instance based on vehicle movement since the prior time instance. The voxel grid may be shifted by both adding voxels to a front face of a voxel grid for a prior time instance wherein the number of voxels added corresponds to the amount of vehicle movement in the front face direction over the time increment and removing voxels from a rear face of the voxel grid for the prior time instance wherein the number of voxels removed corresponds to the amount of vehicle movement in the direction opposite to the rear face direction over the time increment.

The example object identification/lidar beam tracing module 508 is configured to identify an object in the voxel grid 507 by tracing lidar beams from a lidar system on the vehicle 500 through the voxel grid 507 thereby generating a traced voxel grid 509. The example lidar beam tracing module is configured to trace lidar beams through a voxel grid 507 by characterizing a voxel as clear if a lidar beam travels through the voxel, characterizing a voxel as unknown if no lidar beam travels through voxel, and characterizing a voxel as occupied if a lidar beam terminates at that voxel. The example lidar beam tracing module 508 is configured to trace lidar beams using the lidar point cloud data 501, lidar position information 503 relative to the vehicle, and vehicle position information 505 from other vehicle systems. The example lidar beam tracing module 508 is configured to output a traced voxel grid 509 after lidar beam tracing. Identifying an object in the voxel grid 507 includes identifying voxels that have been characterized as occupied.

The example pixel module 510 is configured to determine the velocity of pixels in a camera image that correspond to voxels that have been characterized as occupied. The example pixel module 510 includes a camera image retrieval module 516 that is configured to retrieve a sequence of camera images that encompass the object.

The example pixel module 510 further includes a pixel to voxel matching module 520 that is configured to match pixels in the sequence of camera images that encompass the object to corresponding voxels in the voxel grid that encompass the object. The example pixel to voxel matching module 520 is configured to match pixels to corresponding voxels by synchronizing the position and time of the pixels with the position and time of the voxels.

The example pixel module 510 further includes a pixel velocity determination module 518 that is configured to determine the velocity of the pixels that encompass the object from the sequence of camera images. The example pixel velocity determination module 518 is configured to determine the velocity of the pixels by analyzing the movement of the object in successive images in the sequence of images.

The example voxel velocity determination module 512 is configured to infer the velocity of the corresponding voxels that encompass the object based on the velocity of the pixels that encompass the object. The example voxel velocity determination module 512 is configured to infer the velocity using machine learning techniques.

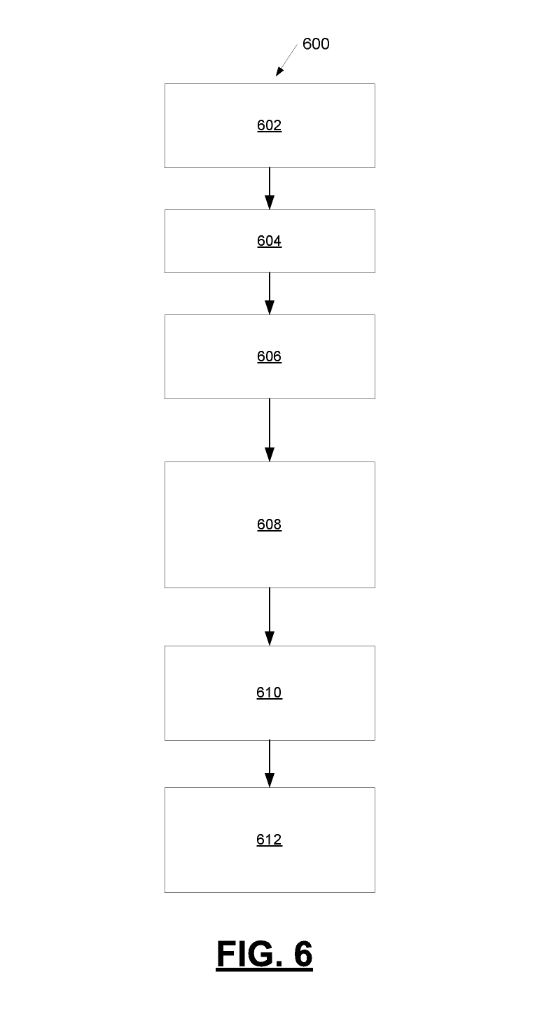

FIG. 6 is a process flow chart depicting an example process 600 in a vehicle for determining and outputting the velocity of lidar points. The order of operation within the process is not limited to the sequential execution as illustrated in the figure, but may be performed in one or more varying orders as applicable and in accordance with the present disclosure. In various embodiments, the process can be scheduled to run based on one or more predetermined events, and/or can run continuously during operation of the vehicle.

The example process 600 includes constructing a voxel grid around a vehicle (operation 602). The example voxel grid may be constructed using retrieved lidar point cloud data, lidar position information relative to the vehicle, and vehicle position information from other vehicle systems. The example voxel grid for the current time may be constructed by shifting a voxel grid from a prior time instance based on vehicle movement since the prior time instance. The voxel grid may be shifted by both adding voxels to a front face of a voxel grid for a prior time instance wherein the number of voxels added corresponds to the amount of vehicle movement in the front face direction over the time increment and removing voxels from a rear face of the voxel grid for the prior time instance wherein the number of voxels removed corresponds to the amount of vehicle movement in the direction opposite to the rear face direction over the time increment.

The example process 600 includes identifying an object in the voxel grid (operation 604). Identifying an object in the voxel grid in this example includes tracing lidar beams from a lidar system on the vehicle through the voxel grid. Tracing lidar beams through the voxel grids may be accomplished by characterizing a voxel as clear if a lidar beam travels through the voxel, characterizing a voxel as unknown if no lidar beam travels through voxel, and characterizing a voxel as occupied if a lidar beam terminates at that voxel. Lidar point cloud data, lidar position information relative to the vehicle, and vehicle position information from other vehicle systems may be used during lidar beam tracing operations. Identifying an object in the voxel grid includes identifying voxels that have been characterized as occupied.

The example process 600 includes retrieving a sequence of camera images that encompass the object (operation 606) and matching pixels in the sequence of camera images that encompass the object to corresponding voxels in the voxel grid that encompass the object (operation 608). Matching pixels in the sequence of camera images that encompass the object to corresponding voxels may include synchronizing the position and time of the pixels with the position and time of the voxels.

The example process 600 includes determining the velocity of the pixels that encompass the object from the sequence of camera images (operation 610). Determining the velocity of the pixels may include analyzing the movement of the object in successive images in the sequence of images.

The example process 600 includes inferring the velocity of the corresponding voxels that encompass the object based on the velocity of the pixels that encompass the object (operation 612). Machine learning techniques may be applied to infer the velocity of the corresponding voxels that encompass the object based on the velocity of the pixels that encompass the object.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. Various changes can be made in the function and arrangement of elements without departing from the scope of the disclosure as set forth in the appended claims and the legal equivalents thereof.

What is claimed is:

1. A processor-implemented method in a vehicle for detecting the motion of lidar points and generating a two-dimensional (2D) top-down map that identifies moving objects, the method comprising:
constructing, by the processor, a sequence of computer-generated voxel grids surrounding the vehicle at each of a plurality of successive time increments, the sequence of voxel grids including a voxel grid for the current time and a voxel grid for each of a plurality of past time instances;
tracing, by the processor, in each voxel grid in the sequence, lidar beams from a lidar system on the vehicle through the voxel grid;
analyzing, by the processor, differences across the sequence of voxel grids to produce a motion score for a plurality of regions in the voxel grid for the current time that characterizes the degree of motion in the region over the successive time increments;
summing, by the processor, the motion scores of the regions across columns to produce a summed motion score for each column of regions;
producing, by the processor, a 2D image from the summed motion scores.

2. The method of claim 1, wherein the plurality of successive time increments comprises at least eight successive time increments.

3. The method of claim 1, wherein constructing a sequence of computer-generated voxel grids comprises constructing a voxel grid for the current time by adding voxels to a front face of a voxel grid for a prior time instance wherein the number of voxels added corresponds to the amount of vehicle movement in the front face direction and removing voxels from a rear face of the voxel grid for the prior time instance wherein the number of voxels removed corresponds to the amount of vehicle movement in the direction opposite to the rear face direction.

4. The method of claim 1, wherein analyzing differences across the sequence of voxel grids comprises applying a machine learning classifier to the successive images.

5. The method of claim 4, wherein analyzing differences across the sequence of voxel grids comprises applying a random forest classifier to the successive images.

6. The method of claim 1, wherein analyzing differences across the sequence of voxel grids to produce a motion score for a plurality of regions in the voxel grid comprises:
sub-dividing the voxel grid for the current time into a plurality of regions;
identifying the regions in the voxel grid for the current time that contain occupied voxels; and
producing a motion score for each identified region that characterizes the degree of motion in the identified region over the successive time increments by analyzing differences between the voxels in the identified regions and the voxels in corresponding regions in the voxel grids for past time instances.

7. The method of claim 1, wherein a region comprises a rectangular prism of voxels.

8. The method of claim 1, wherein the 2D image identifies objects that are in motion.

9. The method of claim 8, wherein the 2D image identifies the velocity of objects that are in motion.

10. The method of claim 1, wherein an identified region comprises a region wherein a lidar beam terminates in the center voxel of the region.

11. The method of claim 1, wherein tracing lidar beams through the voxel grid comprises:
assigning a first characteristic to a voxel if a lidar beam travels through the voxel;
assigning a second characteristic to a voxel if no lidar beam travels through voxel; and
assigning a third characteristic to a voxel if a lidar beam terminates at that voxel.

12. The method of claim 11, wherein the first characteristic is clear, the second characteristic is unknown, and the third characteristic is occupied.

13. A processor-implemented method in a vehicle for determining the velocity of lidar points, the method comprising:
constructing, by a processor, a voxel grid around the vehicle;
identifying, by the processor, an object in the voxel grid;
retrieving, by the processor, a sequence of camera images that encompass the object;
matching, by the processor, pixels in the sequence of camera images that encompass the object to corresponding voxels in the voxel grid that encompass the object;
determining, by the processor, the velocity of the pixels that encompass the object from the sequence of camera images; and
inferring, by the processor, the velocity of the corresponding voxels that encompass the object based on the velocity of the pixels that encompass the object.

14. The method of claim 13, wherein determining the velocity of the pixels comprises analyzing the movement of the object in successive images in the sequence of images.

15. The method of claim 13, wherein identifying an object in the voxel grid comprises tracing lidar beams from a lidar system on the vehicle through the voxel grid.

16. The method of claim 15, wherein tracing lidar beams through the voxel grid comprises:
assigning a first characteristic to a voxel if a lidar beam travels through the voxel;
assigning a second characteristic to a voxel if no lidar beam travels through voxel; and
assigning a third characteristic to a voxel if a lidar beam terminates at that voxel.

17. The method of claim 16, wherein the first characteristic is clear, the second characteristic is unknown, and the third characteristic is occupied.

18. The method of claim 17, wherein identifying an object in the voxel grid comprises identifying voxels that have been assigned an occupied characteristic.

19. The method of claim 13, wherein matching pixels in the sequence of camera images that encompass the object to corresponding voxels comprises synchronizing the position and time of the pixels with the position and time of the voxels.

20. An autonomous vehicle comprising:
an imaging system configured to generate image data;
a lidar system configured to generate lidar data; and
a velocity mapping system configured to infer from the image data the velocity of voxels that encompass an object based on the velocity of pixels in the image data, the velocity mapping system comprising one or more processors configured by programming instructions encoded in non-transient computer readable media, the velocity mapping system configured to:
construct a voxel grid around the vehicle;
identify an object in the voxel grid;
retrieve a sequence of camera images that encompass the object;
match pixels in the sequence of camera images that encompass the object to corresponding voxels in the voxel grid that encompass the object;
determine the velocity of the pixels that encompass the object from the sequence of camera images; and
infer the velocity of the corresponding voxels that encompass the object based on the velocity of the pixels that encompass the object.
